(19) United States
(12) Patent Application Publication
(10) Pub. No.: US 2004/0153993 A1
(43) Pub. Date: Aug. 5, 2004

(54) Package method of intellectual pointer of invoking component object function

(76) Inventors: Rong Chen, Shanghai (CN); Zhongqiang Ye, Shanghai (CN); Yuzhou Liang, Shanghai (CN)

Correspondence Address: RABIN & BERDO, P.C., Suite 500, 1101 14th Street, N.W., Washington, DC, 20005, US

(21) Appl. No.: 10/747,103

(22) Filed: Dec. 30, 2003

(30) Foreign Application Priority Data
Dec. 31, 2002 (CN) 02159487.2

(51) Int. Cl. G06F 9/44

(52) U.S. Cl. 717/108

(57) ABSTRACT

A package method of intellectual pointer of invoking component object function, in case of the interface intellectual pointer is transfer to the parameter of invoking part as a invoke method of component object, the reference count is not be increased or decreased; in case of the interface intellectual pointer is structured, analyzed or assigned, the reference count is increased or decreased; the class intellectual pointer includes element variable correspond to the interface realized by component object, the element variable is for invoking component object realizing interface method; the category intellectual pointer includes element variable corresponding to all the interfaces in category, this element variable is for the interface method invoking of all the interfaces in the category realized by component object inheriting the category. Present invention realizes the intellectual manage reference count and component creating, the programming complexity is reduced, and realizes a “multi-modes” in object creating.

### FIELD OF THE INVENTION

The present invention relates to a package method of intellectual pointer of invoking component object function, especially relates to a package method of intellectual pointer for transferring the invoker part parameter or invoking component object interface function in time of component object creating, the present invention belongs to the computer technology field.

### BACKGROUND OF THE INVENTION

Since 80's, the software programming technology has a rapid development, and it may be divided into the following 3 stages:

Object oriented programming, i.e. the software module is independent by packaging for simplifying. The object oriented programming laid stress on the object package, however the relation between modules (objects) was fixed in compiling time, the relation between modules is static and couldn't be changed in program operation; i.e. the smaller function unit in module couldn't be utilized instead in operation.

Component oriented programming, i.e. in order to utilize interchangeably the component modules (software object) provided by various software developer, the connection and invoking between components is realized through standard protocol. The component-wise programming model stress on the protocol standard, and needs the protocol that all makers could comply with. It likes just the standard screws and nuts interchangeable installation. The component-wise programming model is on basis of object oriented technology, and provides a dynamic structure module (structure the module in operation) mechanism. The component may be uploaded in operation and changeable. However the present component oriented programming technology requires user to self define the non-self description interface and makes the user program development is still complicated.

The intellectual pointer is used for pointer function packaging. Some current intellectual pointers are used for component object model (COM) interface pointer, the intellectual pointers could inquire automatically the interface, handle the count increasing or decreasing or component analysis and could invoke the component object interface function.

Take C++ program as a example, in COM programming, a object CObject realizes a interface IA, IB and IC; interface IA includes function FA, interface IB includes function FB, and interface IC includes function FC. So, if user want to invoke the function FA,FB,FC, it need to write the below C++codes, (suppose user has obtained the interface pointer pIA of interface IA).

.....
pIA? FA(...)
IB*pIB;
IC*pIC
PIA? QueryInterface(IID-IB,&pIB);
PIA? QueryInterface(IID-IC,&pIC);
PIB? FB(...);
PIC? FC(...);
PIB? Release( );
PIC? Release( );
....

It doesn't consider the function invoking failure to C++ codes above for simple. Thus user needs programming 9 lines of program and this leads to complication.

### BRIEF DESCRIPTION OF THE INVENTON

The main purpose of present invention is providing a realizing method of component terminal interface intellectual pointer, used for component invoke part to access the function specified by the interface through interface intellectual pointer, and realize intellectual managing reference count and component object creating.

The other purpose of present invention is providing a intellectual pointer package method accessing directly the component interface, invoke all the interface functions realized by component object through class intellectual pointer, and lower the programming complicity.

The other purpose of present invention is providing a intellectual pointer package method based on category, the element variable in category intellectual pointer is corresponding to all the interfaces in component class of same characteristic, and is used for invoking all the interface functions realized by component object, and lower the programming complicity.

The purpose of present invention is realized as follows:

A component terminal interface intellectual pointer realization method;

The first class interface intellectual pointer is realized by a class, in case of the first class interface intellectual pointer is transferring the parameter to the invoked part of the component object as a invoke part of component object, the reference count is not be increased or decreased;

The second class interface intellectual pointer is realized by a class, in case of the second class interface intellectual pointer is utilized for structuring, analyzing and assigning of component object interface function of invoked part, the reference count is increased or decreased;

The first and second class interface intellectual pointers are utilized for component object creating.

When structuring an interface intellectual pointer object, and a non-null interface pointer is copied from a storage position to another storage position, a reference count is increased.

When analyzing an interface intellectual pointer object, or it is assigned between two intellectual pointer object, for the storage position which has included the non-null interface component, a reference count is reduced before over-writing the storage position.

A intellectual pointer package method accessing directly all the functions of component object, the class intellectual pointer has element variable corresponding to more interfaces realized by component object, the element variable is utilized for invoking of interface function of correspond interface realized by component object. There are at least one of said element variable, and the quantity of element variable is equal or not equal to quantity of interface realized by component object.

The concrete realizing method of class intellectual pointer are: the class intellectual pointer is realized through inheriting interface intellectual pointer.

The concrete realizing method of said class intellectual pointer is: the class intellectual pointer sets the element variable corresponding to component object realizing interface directly in the class, and realizes all the interface functions realized by the component object.

A category based package method of intellectual pointer, the category intellectual pointer includes element variable corresponding to all the interfaces in category, the element variable is utilized for invoking all the interface functions in the category realized by the component object inheriting the category.

Said category intellectual pointer has one or more element variables, and the quantity of element variable is equal to quantity of interfaces realized by component object in the class; the category intellectual pointer is for creating the component object.

The concrete realizing method of said category intellectual pointer are: the category intellectual pointer is realized through inheriting interface intellectual pointer.

The concrete realizing method of said category intellectual pointer is: the category intellectual pointer includes element variable corresponding to all the interfaces in category, the element variable is utilized for invoking all the interface functions in the category realized by the component object inheriting the category.

The component invoke part access the function specified by the interface through interface intellectual pointer in present invention, and realize intellectual managing reference count; all the interface functions realized by component object are invoked through class intellectual pointer, the programming complexity is reduced; the element variable in class intellectual pointer is corresponding to all the interfaces of same characteristic component, and convenience to component object setup.

### BRIEF DESCRIPTION OF THE APPENDED DRAWINGS

FIG. 1 is an illustrative view showing the relation between interfaces realized by element variable and component object in interface intellectual pointer of present invention.

FIG. 2 is an illustrative view showing the interface intellectual pointer invoking the component object to realize the corresponding function in present invention.

FIG. 3 is an illustrative view showing the inheriting relation between various interface intellectual pointers in present invention.

FIG. 4 is an illustrative view showing the inheriting relation of interface intellectual pointer by class intellectual pointer in present invention.

FIG. 5 is an illustrative view showing the relation between interfaces realized by element variable and component object in class intellectual pointer of present invention.

### DETAILED DESCRIPTION OF THE INVENTION

The present invention is as below according to figures and Detailed embodiment:

In component object based platform, user may access the method defined by the interface through interface intellectual pointer, so the interface intellectual pointer is a package to interface, the realization of interface intellectual pointer in present invention is based on C++ programming language as below:

Define the interface intellectual pointer as a class, there is only one element variable in the class, and the element variable is a real interface pointer pointing to object interface.

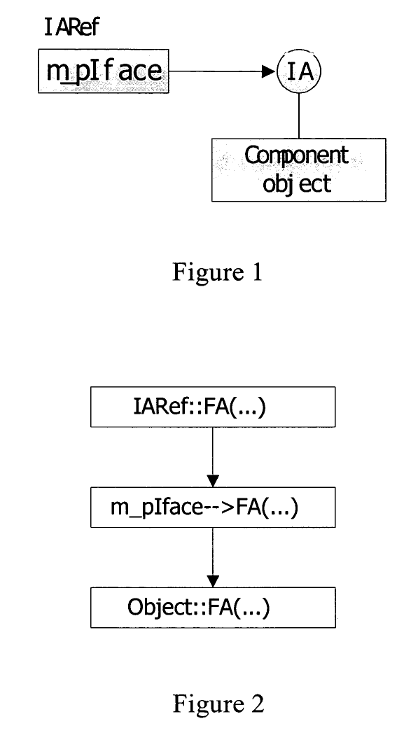

Refer to FIGS. 1 and 2, the interface intellectual pointer IARef is responding to interface IA. The interface intellectual pointer class realizes all the methods of the interface, these interface methods are realized through element variable invoking component object.

In the embodiment, when a interface intellectual pointer object is structured, and a non-null interface pointer is copied from a storage position to another, the add reference function (ADDRef) should be invoked for notifying the object that one more reference occurred;

When a interface intellectual pointer object is analyzed or two intellectual pointer objects are assigned, for the storage position including the non-null interface pointer, the release function must be invoked before overwriting the storage position, and notify the component object for “the reference has been canceled”;

When the interface intellectual pointer is as a entry (“[in]”) interface parameter, the ADDRef and Release functions above may be omitted.

Two types of intellectual pointer are realized in the embodiment, one is used only as a [in] parameter, another one inherits the above intellectual pointer, in analyzing and assignment, the reference count is increased or decreased.

Take C++ programming language as a example, if the interface intellectual pointer IXXXRefArg is realized as a [in] interface parameter, as the inheriting of interface intellectual pointer IXXXRefArg, the structure, analyzing and assignment in interface intellectual pointer IXXXRef are acting for reference count increasing or decreasing.

For the two interface intellectual pointer class of IUnknown interface (the IUnknown is a interface of U.S. Microsoft Co. COM specification), i.e. the interface intellectual pointer class InterfaseRefArg and interface intellectual pointer class InterfaseRef, the interface intellectual pointer class InterfaseRef inherits the interface intellectual pointer class InterfaseRefArg. interface intellectual pointer class InterfaseRefArg defines a element variable IUnknown* m-piface. Other interface intellectual pointers all inherit the class, so all the interface intellectual pointers have the element variable IUnknown*m-piface.

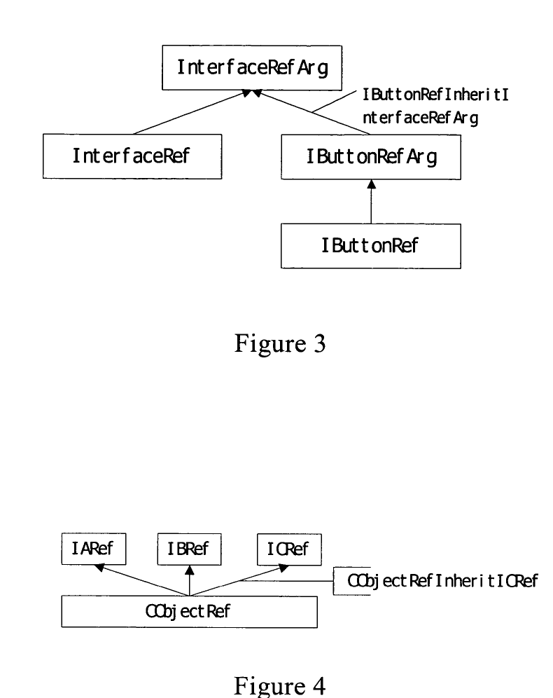

As all the interfaces are inherited from Iunknown, all the interface intellectual pointers are inherited from InterfaseRefArg. Refer to FIG. 3, take interface Ibutton as a example: interface intellectual pointer class IbuttonRef are inherited from interface intellectual pointer class IbuttonRefArg, interface intellectual pointer class IbuttonRefArg and InterfaseRef are both inherited from interface intellectual pointer class InterfaseRefArg.

The component object realized the interface is may be created through interface intellectual pointer, and make the element variable of intellectual pointer to point to the new created component object.

For resolving the problem of code complexity in programming, the component is packaged by class intellectual pointer in present invention, suppose that there is a class intellectual pointer variable m-cObject pointing to CObject above, the codes invoking FA,FB,FC functions are:

m-cObject. FA(...);
m-cObject. FB(...);
m-cObject. FC(...);

it may be seen that the code and program is easy by class intellectual pointer. Take C++ language as a example: the class intellectual pointer is a class, this class has some element variables. Each element variable points to a interface of component object, the quantity of element variable is equal to the interface quantity realized by component object. The element variable is corresponding to the interface realized by component object. Through the class intellectual pointer, all the interface functions realized by component object may be invokeed. As mentioned above, by the class intellectual pointer m-cObject, the interface function FA of interface IA, the interface function FB of interface IB and interface function FC of interface IC may be invoked.

The realization of class intellectual pointer may has two ways in present invention:

Refer to FIG. 4 and take C++ language as a example, the first realization way of class intellectual pointer is: the class intellectual pointer inherits the interface intellectual pointer directly; in this condition, when user invoke the function CobjectRef::FA( . . . ) realized by component object, in fact it invoke the interface intellectual pointer IARef::FA( . . . ) corresponding to intellectual pointer IARef.

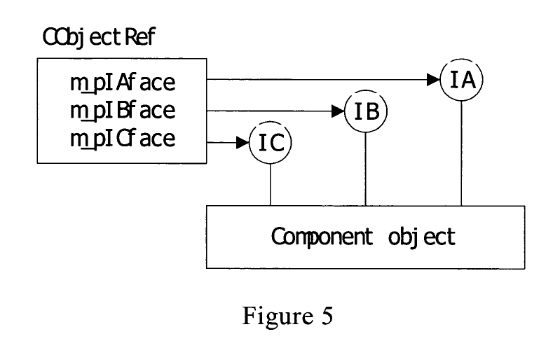

Refer to FIG. 5, the second realization way of class intellectual pointer is: the class intellectual pointer doesn't inherit the interface intellectual pointer corresponding to all interfaces realized by component object, but define directly some element variables in the class, each element variable relates to a interface of component object, the quantity of element variable is equal to the interface quantity realized by component object. The class intellectual pointer may be used to realize all the interface function realized by the component object.

In this condition, when user invokes the function CobjectRef::FA( . . . ), the function CobjectRef::FA( . . . ) realized by component object will invoke element variable m-pIAface? FA( . . . ).

Apart from above example, for class intellectual pointer, the more interface functions of interface realized by component object may be-ed. The difference between class intellectual pointer and interface intellectual pointer is, interface intellectual pointer invoke more interface method of only one interface, but class intellectual pointer could invoke more interface method of one component object. In practice, class intellectual pointer may invoke one or more interfaces according to purpose, e.g. if for the three interfaces, the programmer hopes to utilize only two by user with the third one not exposed, in class intellectual pointer realization, make the class intellectual pointer only invoke two interfaces. There are element variable corresponding to the interface realized by component object in class intellectual pointer, it makes the element variable not always correspondent to the interface realized by component object, the quantity of element variable maybe more, less or equal to the interface realized by component object. Even haven't set the element variable in class intellectual pointer packaging, the class intellectual pointer function may also be realized.

The component object corresponding to the class intellectual pointer may be created through class intellectual pointer, and make the element variable inherited from the class intellectual pointer is pointing to the new created object.

For resolving the problem of code complexity in programming and convenient to the flexible setting of component object, the component is packaged by category intellectual pointer in present invention.

As the interface intellectual pointer is a packaging to interface, the category intellectual pointer is the packaging to category. The component objects which have same property are divided into a class in present invention. For example, various acoustic cards are used for sound recording and play with relative driving program, so each kind of driving program may be formed as a card component class; each component class has some interfaces, all the card driving components include a same interface group. A class is a interface group and used for inheriting the component class and category. All the inheriting component class realize all the interfaces included in the category. After inheriting the category, its interface group becomes the co-group of tow interface groups.

The difference between category and component class is: the category is a interface group and for inherited; the component class is also a interface group but couldn't be inherited; all the component class of category inheriting must realize all the interfaces included by the category.

The realization of category intellectual pointer is same as the class intellectual pointer in present invention, i.e. the category intellectual pointer is realized by same way of class intellectual pointer.

While the present invention has been particularly shown and described with references to preferred embodiments thereof, it is clearly understood that the same is by way of illustration and example only and is not to be taken by way of limitation, it will be understood by those skilled in the art that various variations, alterations, and modifications in form and details may be made therein without departing from the spirit and scope of the invention as defined by the claims and it intended to be encompassed in the scope of the present invention.

We claim:

1. A component terminal interface intellectual pointer realization method, characterized in that:
The first class interface intellectual pointer is realized by a class, in case of the first class interface intellectual pointer is transferring the parameter to the invoked part of the component object as a invoke part of component object, the reference count is not be increased or decreased;
The second class interface intellectual pointer is realized by a class, in case of the second class interface intellectual pointer is utilized for structuring, analyzing and assigning of component object interface function of invoked part, the reference count is increased or decreased;
The first and second class interface intellectual pointers are utilized for component object creating.

2. A component terminal interface intellectual pointer realization method according to claim 1, characterized in that:
When structuring an interface intellectual pointer object, and a non-null interface pointer is copied from a storage position to another storage position, a reference count is increased.

3. A component terminal interface intellectual pointer realization method according to claim 1, characterized in that:
When analyzing an interface intellectual pointer object, or it is assigned between two intellectual pointer object, for the storage position which has included the non-null interface component, a reference count is reduced before over-writing the storage position.

4. A intellectual pointer package method accessing directly all the functions of component object, characterized in that:
The class intellectual pointer has element variable corresponding to more interfaces realized by component object, the element variable is utilized for invoking of interface function of correspond interface realized by component object.

5. A intellectual pointer package method accessing directly all the functions of component object according to claim 4, characterized in that:
There are at least one of said element variable, and the quantity of element variable is equal to one of interface realized by component object.

6. A intellectual pointer package method accessing directly all the functions of component object according to claim 4, characterized in that:
There are at least one of said element variable, and the quantity of element variable is not equal to one of interface realized by component object.

7. A intellectual pointer package method accessing directly all the functions of component object according to claim 5, characterized in that:
The concrete realizing method of said class intellectual pointer are: the class intellectual pointer is realized through inheriting interface intellectual pointer.

8. A intellectual pointer package method accessing directly all the functions of component object according to claim 7, characterized in that:
In case of the interface intellectual pointer is transferring the parameter to the invoked part interface function as a invoke part, the reference count is not be increased or decreased; in case of the interface intellectual pointer is utilized for structuring, analyzing and assigning of component object interface function of invoked part, the reference count is increased or decreased.

9. A intellectual pointer package method accessing directly all the functions of component object according to claim 8, characterized in that:
When structuring an interface intellectual pointer object, and a non-null interface pointer is copied from a storage position to another storage position, a reference count is increased.

10. A intellectual pointer package method accessing directly all the functions of component object according to claim 8, characterized in that:
When analyzing an interface intellectual pointer object, or it is assigned between two intellectual pointer objects, for the storage position which has included the non-null interface pointer, a reference count is reduced before over-writing the storage position.

11. A intellectual pointer package method accessing directly all the functions of component object according to claim 5, characterized in that:
The concrete realizing method of said class intellectual pointer is: the class intellectual pointer sets the element variable corresponding to component object realizing interface directly in the class, and realizes all the interface functions realized by the component object.

12. A category based package method of intellectual pointer, characterized in that:
The category intellectual pointer includes element variable corresponding to all the interfaces in category, the element variable is utilized for invoking all the interface functions in the category realized by the component object inheriting the category.

13. A category based package method of intellectual pointer according to claim 12, characterized in that:
Said category intellectual pointer has one or more element variables, and the quantity of element variable is equal to quantity of interfaces realized by component object in the class; the category intellectual pointer is for creating the component object.

14. A category based package method of intellectual pointer according to claim 13, characterized in that:
The concrete realizing method of said category intellectual pointer are: the category intellectual pointer is realized through inheriting interface intellectual pointer.

15. A category based package method of intellectual pointer according to claim 14, characterized in that:
In case of the interface intellectual pointer is transferring the parameter to the invoked part interface function as a invoke part, the reference count is not be increased or decreased; in case of the interface intellectual pointer is utilized for structuring, analyzing and assigning of interface function of invoked part, the reference count is increased or decreased.

16. A category based package method of intellectual pointer according to claim 15, characterized in that:
When structuring an interface intellectual pointer object, and a non-null interface pointer is copied from a storage position to another storage position, a reference count is increased.

17. A category based package method of intellectual pointer according to claim 15, characterized in that:
When analyzing an interface intellectual pointer object, or it is assigned between two intellectual pointer objects, for the storage position which has included the non-null interface pointer, a reference count is reduced before over-writing the storage position.

18. A category based package method of intellectual pointer according to claim 13, characterized in that:
The concrete realizing method of said category intellectual pointer is: the category intellectual pointer includes element variable corresponding to all the interfaces in category, the element variable is utilized for invoking all the interface functions in the category realized by the component object inheriting the category.
